(19) United States
(12) Patent Application Publication
(10) Pub. No.: US 2010/0241987 A1
(43) Pub. Date: Sep. 23, 2010

(54) Tear-Drop Way-Finding User Interfaces

(75) Inventors: V. Kevin Russ, Bellevue, WA (US); John A. Snavely, Seattle, WA (US); Edwin R. Burtner, Everett, WA (US); Ian M. Sands, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/407,009

(22) Filed: Mar. 19, 2009

(51) Int. Cl. G06F 3/048

(52) U.S. Cl. 715/784; 715/810

(57) ABSTRACT

A tear-drop way-finding user interface (UI) may be provided. A first UI portion corresponding to a device location may be provided. In addition, an object may be displayed at a first relative position within the first UI portion. Then, upon a detected change in device location, a second UI portion corresponding to the changed device location may be provided. In response to the changed device location, a second relative position of the object may be calculated. Next, a determination may be made as to whether the second relative position of the object is within a displayable range of the second UI portion. If the second relative position of the object is not within the displayable range of the second UI portion, then a tear-drop icon indicative of the second relative position of the object may be displayed at an edge of the second UI portion.

### RELATED APPLICATIONS

Related U.S. application Ser. No. ______, entitled “Gesture Operated User Interfaces” (14917.1226US01), related U.S. application Ser. No. ______, entitled “Dual Module Portable Device” (14917.1224US01), and U.S. application Ser. No. ______, entitled “Projected Way-Finding” (14917.1223US01), filed on even date herewith, assigned to the assignee of the present application, are hereby incorporated by reference.

### BACKGROUND

A graphical user interface (GUI) allows a user to interact with electronic devices, such as computers, hand-held devices, household appliances, and office equipment. A GUI offers graphical elements and visual indicators, as opposed to text-based interfaces, typed command labels, or text navigation, to fully represent information and actions available to the user. The actions are usually performed through direct manipulation of the graphical elements. A GUI uses a combination of technologies and devices to provide a platform the user can interact with.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

A tear-drop way-finding user interface (UI) may be provided. A first UI portion corresponding to a device location may be provided. In addition, an object may be displayed at a first relative position within the first UI portion. Then, upon a detected change in device location, a second UI portion corresponding to the changed device location may be provided. In response to the changed device location, a second relative position of the object may be calculated. Next, a determination may be made as to whether the second relative position of the object is within a displayable range of the second UI portion. If the second relative position of the object is not within the displayable range of the second UI portion, then a tear-drop icon indicative of the second relative position of the object may be displayed at an edge of the second UI portion.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a diagram of an operating environment;

FIG. 2 is another diagram of an operating environment;

FIG. 3 is a flow chart of a method for providing a tear-drop user interface; and

FIG. 4 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

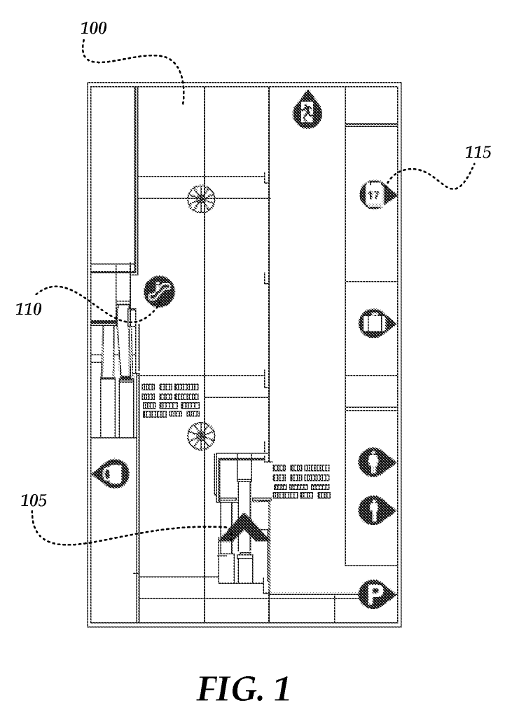

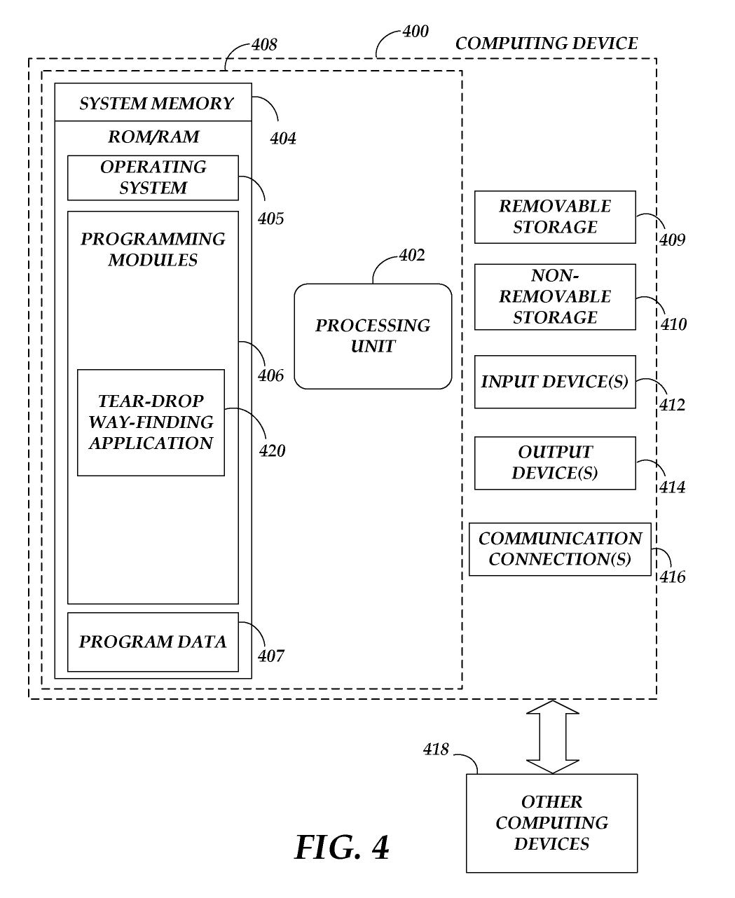

FIG. 1 is a diagram of an operating environment. As shown in FIG. 1, a user interface 100 may be provided to a computing device (e.g. a computing device 400 as described in more detail below with respect to FIG. 4). The computing device may be a portable device comprising, but not limited to, a communications device, a mobile communications device capable of providing voice and data services, a mobile device comprising a camera and speakers, a personal digital assistant, a telephone, a cellular telephone, a smart phone, a computer, or a handheld computer.

Consistent with embodiments of the invention, user interface 100 may provide a map corresponding to an environment associated with the portable device's current location. The portable device's current location may be detected by a position detecting device integrated into the portable device. The position detecting device may be operative to communicate with a global or local positioning system and detect the current location by way of, for example, device triangulation. The detected portable device's location may be displayed within user interface 100 as, for instance, a carrot 105. In other embodiments of the invention, the portable device's current location may be represented by any location indicator. In addition, user interface 100 may include objects, such as object 110, representing, for example, tracked physical objects, places, people, or events located within the map. In this way, user interface 100 may provide a user of the portable device with his current location, as well as the location of people, places, events, and objects around him for example.

Furthermore, user interface 100 may be displayed to accommodate a display size of the portable device. As a result, due to a potentially limited display size of the portable device, the user interface 100 may not be displayed in its entirety. Consistent with embodiments of the invention, when user interface 100 represents, for example, the map as discussed above, objects falling outside of a viewable portion of the map may be represented as tear-drop icons, such as tear-drop icon 115. The tear-drop icons may cling to a point on a periphery of user interface 100, pointing to the respective objects' location. In this way, the user of the portable device may be provided with an object's relative location when the object may not have been otherwise displayable within the viewable portion of the map.

Consistent with embodiments of the invention, user interface 100 may be modified to correspond to changes in a physical environment associated with the portable device's location. In other words, as the user of the portable device navigates through the physical environment, user interface 100 may be modified to reflect representations of portions of the physical environment now within a viewable range associated with the portable device's display size. For instance, as the portable device is propagated through the physical environment, carrot 105, reflecting the portable device's current location, may remain at a fixed position while the displayed objects change in their relative position within user interface 100. So, for example, if the user of the portable device navigates away from, for example, a place, person, object, or event represented by a corresponding object in user interface 100, the corresponding object may eventually fall outside of the viewable portion of user interface 100. In such circumstance, when the corresponding object is no longer displayable within the viewable portion of user interface 100, an associated tear-drop icon may be displayed at an edge of user interface 100, indicating to the object's relative position to the user. Eventually, however, as the user navigates beyond a threshold proximity from the corresponding object, the associated tear-drop icon may ‘fall off’, or no longer be displayed at the periphery of user interface 100.

Moreover, as an orientation of the portable device changes, the associated tear-drop icon may track along the periphery of user interface 100, following the corresponding object's change in relative position to the portable device. For example, as the user rotates 180 degrees clockwise within the environment, the tear-drop icons may slide 180 degree's counter-clockwise along the periphery of user interface 100. Consistent with embodiments of the present invention, the portable device's orientation may be detected by an orientation detector integrated into the portable device. The orientation detector may comprise, for example, a compass to detect a direction of the portable device.

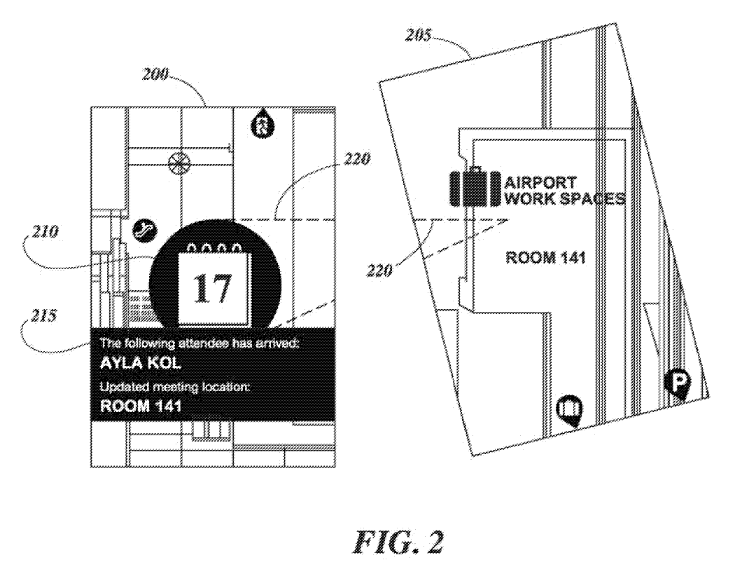

FIG. 2 is another diagram of an operating environment. As shown in FIG. 2, a first user interface portion 200 and a second user interface portion 205 may be provided in accordance with embodiments of dual module portable device 100 as detailed in U.S. application Ser. No. ______ (‘Dual Module Portable Device,’ Attorney Docket No. 14917.1224US01). Furthermore, first user interface portion 200 and second user interface portion 205 may each include the icons, objects, features, and operations of user interface 100 as described above with reference to FIG. 1. Similarly, user interface 100 may include the icons, objects, features, and operations of either first user interface portion 200 or second user interface portion 205.

Consistent with embodiments of the invention, first user interface portion 200 may provide contextual information 215 associated with object 210. Contextual information 215 associated with object 210 may be provided in response to various stimuli. For example, object 210 may be a physical object, person, place, or event within an environment represented by either first user interface portion 200 or second user interface portion 205. In response to a user selection of object 210, which may have been displayed in first user interface portion 200 as a tear-drop icon, contextual information 215 may be provided in a center of first user interface portion 200. Similarly, a selection of an object or tear-drop icon within second user interface portion 205 may cause a provision of contextual information associated with the object in a center of second user interface portion 205.

In various other embodiments of the invention, contextual information 215 may be provided in response to a triggered event. For example, when an event represented by object 210 is scheduled to begin, contextual information 215 associated with the event may be provided to alert the user of the event. In addition, projection lines 220 extending from object 210 may point to a place where the event is set to occur. In this way, the user may not only be alerted of the event's commencement, but may also be directed to the event's location. As illustrated in FIG. 2, projection lines 220 may extend beyond first user interface portion 200 and into second user interface portion 205 where the event may be set to occur.

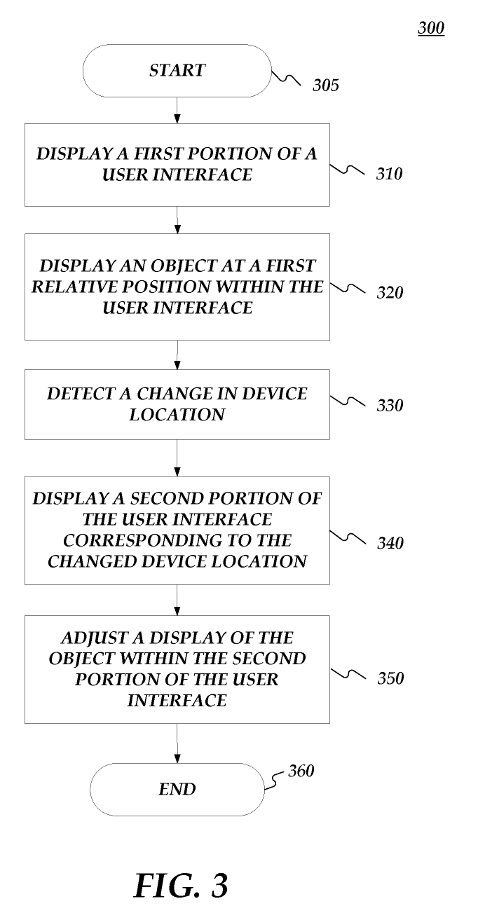

FIG. 3 is a flow chart setting forth the general stages involved in a method 300 consistent with embodiments of the invention for providing tear-drop way-finding user interface. Method 300 may be implemented using computing device 400 (e.g. portable device) as described in more detail below with respect to FIG. 4. Ways to implement the stages of method 300 will be described in greater detail below.

Method 300 may begin at starting block 305 and proceed to stage 310 where computing device 400 may display a first user interface portion. For example, the first user interface portion may correspond to a first portion of a map depicting an environment associated with computing device 400's location. The first portion of the map may be confined to a size of a display device associated with computing device 400 and may include a device location indicator within the map, such as carrot 105 depicted in FIG. 1.

From stage 310, where computing device 400 displays the first user interface portion, method 300 may advance to stage 320 where computing device 400 may display an object at a first relative position within the user interface. For example, the object, such as object 105 shown in FIG. 1, may be tracked by computing device 400 and displayed at a corresponding location within the first user interface portion. The object may provide a visual representation of, for example, a physical object, person, place, or event within a threshold proximity to device 400. In this way, computing device 400 may not only display the environment corresponding to the device location, but may also display various objects within the threshold proximity defined by rules associated with the displayed environment. Consistent with embodiments of the invention, objects located outside of the first user interface portion may be displayed at a boundary of the first user interface portion as tear-drop icons, such as tear-drop icon 115 depicted in FIG. 1. These tear-drop icons may visual depict an object they represent and point to the object's location. Moreover, computing device 400 may indicate a distance of a corresponding object by, for example, varying a color or an opacity of the tear-drop icon representing the corresponding object.

Once computing device 400 displays the object at the first relative position within the user interface at stage 320, method 300 may continue to stage 330 where computing device 400 may detect a change in device location. For example, computing device 400 may include position and orientation detection devices as described above. With these detectors, computing device 400 may not only detect changes in the device location, but may also detect changes in device orientation.

After computing device 400 has detected the change in the device location at stage 330, method 300 may proceed to stage 340 where computing device 400 may display a second user interface portion corresponding to the changed device location. For example, to account for the changed device location or orientation, the first user interface portion may be modified to correspond to the changed location. In this way, the second user interface portion may correspond to a second portion of the map depicting an environment associated with computing device 400's changed location. The second user interface portion may include at least a segment of the first user interface portion, as well as objects displayed in the first user interface portion. In addition, new objects may now fall within the threshold proximity and may be displayed in the second user interface portion. Likewise, objects that no longer fall within the given proximity may be withdrawn from display.

From stage 340, where computing device 400 displays the second user interface portion corresponding to the changed device location, method 300 may advance to stage 350 where computing device 400 may adjust a display of the object with the second user interface portion. For example, as the device location has changed, the position of the object to relative to the device may also have changed. When the changed relative position of the object is still within a viewable range of the second user interface portion, the object may be displayed as object 110 depicted in FIG. 1. However, when the changed relative position of the object is not within the viewable range of the second user interface portion, the object may be displayed as a tear-drop icon, such as tear-drop icon 115 depicted in FIG. 1. The tear-drop icon may be positioned on a boundary of the second user interface portion closest to the object's relative position and point to the object's relative location

Moreover, if the tear-drop icon corresponding to the object's changed relative position is located, for example, in close proximity to another tear-drop icon corresponding to another object's location, the multiple tear-drop icons may be combined into a single icon. This single icon may be represented as, for example, a ‘plus’ sign (+). Upon selection of the single icon, the multiple tear-drop icons may be separated so as to independently indicate their corresponding object's relative position. Once computing device 400 adjusts the display of the object in stage 350, method 300 may then end at stage 360.

An embodiment consistent with the invention may comprise a system for displaying object location within a way-finding user interface system. The system may comprise a memory storage and a processing unit coupled to the memory storage. The processing unit may be operative to display a viewable area of a map corresponding to a first location; display an object at a first relative position within the viewable area of the map; detect a change from the first location to a second location; modify the viewable area of the map to correspond to the second location; determine a second relative position of the object; and display a tear-drop icon at a boundary of the modified viewable area of the map pointing to the second relative position.

Another embodiment consistent with the invention may comprise a system for displaying objects within a user interface. The system may comprise a memory storage and a processing unit coupled to the memory storage. The processing unit may be operative to display a first user interface portion corresponding to a device location; display an object at a first relative position within the first user interface portion; detect a change in device location; display a second portion of the user interface corresponding to the changed device location; determine a second relative position of the object to the changed device location; and display a tear-drop icon at a boundary of the second portion of the user interface closest to the second relative position of the object.

Yet another embodiment consistent with the invention may comprise a system for providing object information within a way-finding user interface. The system may comprise a memory storage and a processing unit coupled to the memory storage. The processing unit may be operative to display a first portion of a user interface corresponding to a device location; display an object at a first relative position within the user interface; detect a change in device location; display a second portion of the user interface corresponding to the changed device location; determine a second relative position of the object to the changed device location; calculate a proximity of the second relative position of the object to the changed device location; determine if the calculated proximity is within a threshold proximity; display, in response to a determination that the second relative position of the object is within the threshold proximity, a tear-drop icon at a boundary of the second portion of the user interface closest to the second relative position of the object; receive a selection of the tear-drop icon; and provide, in response to the received selection of the tear-drop icon, information associated with the object corresponding to the tear-drop icon.

FIG. 4 is a block diagram of a system including computing device 400. Consistent with an embodiment of the invention, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with embodiments of the invention. Furthermore, computing device 400 may comprise an operating environment for system 100 as described above. System 100 may operate in other environments and is not limited to computing device 400.

With reference to FIG. 4, a system consistent with an embodiment of the invention may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include a program data 407. Operating system 405, for example, may be suitable for controlling computing device 400's operation. In one embodiment, programming modules 406 may include a tear-drop way-finding application 420. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402, programming modules 406 (e.g. tear-drop way-finding application 420) may perform processes including, for example, one or more method 300's stages as described above. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for displaying object location within a way-finding user interface, the method comprising:
displaying a viewable area of a map, the viewable area of the map corresponding to a first location;
displaying an object within the viewable area of the map, the object being at a first relative position within a first proximity to the first location;
detecting a change from the first location to a second location;
modifying the viewable area of the map to correspond to the second location; and
adjusting a display of the object within the modified viewable area of the map, wherein adjusting the display of the object within the modified viewable area of the map comprises:
determining a second relative position of the object within a second proximity to the second location, and
when the second proximity is not within range of the modified viewable area of the map, displaying a tear-drop icon at a boundary of the modified viewable area of the map pointing to the second relative position, the boundary of the modified viewable area of the map corresponding to a closest point to the second relative position of the object.

2. The method of claim 1, wherein displaying the tear-drop icon at the boundary of the modified viewable area of the map comprises:
determining if the second proximity is within a threshold proximity, and
displaying, in response to a determination that the second proximity is within the threshold proximity, the tear-drop icon at the boundary of the modified viewable area of the map.

3. The method of claim 1, wherein displaying the tear-drop icon at the boundary of the modified viewable area of the map comprises displaying the tear-drop icon indicative of at least one of the following: the object, the object's relative position, the object's relative direction, and the object's proximity.

4. The method of claim 2, wherein displaying the tear-drop icon indicative of the object's proximity comprises at least one of the following:
displaying the tear-drop icon at an opacity corresponding to the object's proximity, and
displaying the tear-drop icon at a color corresponding to the object's proximity.

5. The method of claim 1, further comprising:
receiving a selection of the tear-drop icon, and
providing, in response to the received selection of the tear-drop icon, information associated with the object corresponding to the tear-drop icon.

6. The method of claim 5, wherein providing, in response to the selection of the tear-drop icon, the information associated with the object corresponding to the tear-drop icon comprises:
displaying the information at a center of the modified viewable area of the map, and
displaying a projected cone that points to the corresponding object's relative location from the center of the modified viewable area of the map, the projected cone indicating one of: the object's relative direction and the object's proximity.

7. The method of claim 1, wherein displaying the tear-drop icon at the boundary of the modified viewable area of the map comprises:
determining if an additional tear-drop icon associated with an additional object is located at the boundary, and
combining, in response to a determination that an additional tear-drop icon associated with the additional object is located at the boundary, the tear-drop icons into a combined icon indicating that at least two tear-drop icons are located at the boundary.

8. The method of claim 7, further comprising:
receiving a selection of the combined icon, and
expanding, in response to the received selection of the combined icon, the at least two tear-drop icons.

9. The method of claim 1, further comprising:
detecting a change in orientation, and
adjusting a display of the tear-drop icon to correspond to the change in orientation, wherein adjusting the display of the tear-drop icon to correspond to the change in orientation comprises displaying the tear-drop icon at a different boundary of the modified viewable area of the map.

10. The method of claim 1, wherein the way-finding user interface system is configured for operation at a mobile device.

11. A computer-readable medium having a set of instructions which when executed performs a method for displaying objects within a user interface, the method executed by the set of instructions comprising:
displaying a first portion of a user interface corresponding to a device location;
displaying an object at a first relative position within the first portion of the user interface;
detecting a change in device location;
displaying a second portion of the user interface corresponding to the changed device location; and
adjusting a display of the object within the second portion of the user interface, wherein adjusting the display of the object within the second portion of the user interface comprises:
determining a second relative position of the object to the changed device location, and
when the second relative position of the object is not within the second portion of user interface, displaying a tear-drop icon at a boundary of the second portion of the user interface closest to the second relative position of the object.

12. The computer-readable medium of claim 11, further comprising:
detecting a change in device orientation, and
adjusting a display of the tear-drop icon to correspond to the change in device orientation, wherein adjusting the display of the tear-drop icon to correspond to the change in device orientation comprises displaying the tear-drop icon at a different boundary of the second portion of the user interface.

13. The computer-readable medium of claim 11, further comprising:
receiving a selection of the tear-drop icon, and
providing, in response to the received selection of the tear-drop icon, information associated with the object corresponding to the tear-drop icon.

14. The computer-readable medium of claim 11, wherein displaying the tear-drop icon at the boundary of the second portion of the user interface closest to the second relative position of the object comprises:
calculating a proximity of the second relative position of the object to the changed device location,
determining if the calculated proximity is within a threshold proximity, and
displaying, in response to a determination that the calculated proximity is within the threshold proximity, the tear-drop icon at the boundary of the second portion of the user interface closest to the second relative position.

15. The computer-readable medium of claim 11, wherein displaying the tear-drop icon at the boundary of the second portion of the user interface closest to the second relative position of the object comprises:
determining if an additional tear-drop icon associated with an additional object is located at the boundary, and
combining, in response to a determination that an additional tear-drop icon associated with the additional object is located at the boundary, the tear-drop icons into a combined icon indicating that at least two tear-drop icons are located at the boundary.

16. The method of claim 15, further comprising:
receiving a selection of the combined icon, and
expanding, in response to the received selection of the combined icon, the at least two tear-drop icons.

17. A system for providing object information within a way-finding user interface, the system comprising:
a memory storage; and
a processing unit coupled to the memory storage, wherein the processing unit is operative to:
display a first portion of a user interface corresponding to a device location,
display an object at a first relative position within the user interface,
detect a change in device location,
display a second portion of the user interface corresponding to the changed device location,
determine a second relative position of the object to the changed device location,
calculate a proximity of the second relative position of the object to the changed device location,
determine if the calculated proximity is within a threshold proximity,
display, in response to a determination that the second relative position of the object is within the threshold proximity, a tear-drop icon at a boundary of the second portion of the user interface closest to the second relative position of the object,
receive a selection of the tear-drop icon, and
provide, in response to the received selection of the tear-drop icon, information associated with the object corresponding to the tear-drop icon.

18. The system of claim 17, wherein the user interface is a map.

19. The system of claim 17, wherein the processing unit is further operative to drop, in response to a determination that the calculated proximity is not within the threshold proximity, the tear-drop from display.

20. The system of claim 17, wherein the processing unit is further operative to:
determine if an additional tear-drop icon associated with an additional object is located at the boundary, and
combine, in response to a determination that an additional tear-drop icon associated with the additional object is located at the boundary, the tear-drop icons into a combined icon indicating that at least two tear-drop icons are located at the boundary.
